(19) United States
(12) Patent Application Publication
(10) Pub. No.: US 2026/0225578 A1
(43) Pub. Date: Aug. 6, 2026

(54) VEHICLE CONTROL DEVICE

(71) Applicant: AISIN CORPORATION, Kariya (JP)

(72) Inventors: Yasuhiro OKAWARA, Kariya-shi (JP); Akihito YAMAMOTO, Kariya-shi (JP); Takashi KATO, Kariya-shi (JP); Atsuki HIRAKU, Kariya-shi (JP)

(73) Assignee: AISIN CORPORATION, Kariya (JP)

(21) Appl. No.: 19/443,645

(22) Filed: Jan. 8, 2026

(30) Foreign Application Priority Data
Feb. 3, 2025 (JP) 2025-016158

(51) Int. Cl. B60W 30/02; G06N 3/092

(52) U.S. Cl. CPC B60W 30/02; G06N 3/092; B60W 2552/35

(57) ABSTRACT

A vehicle control device includes: a vehicle controller transmitting target control amount information to a suspension system to mitigate an impact applied to a vehicle body from a road surface; and a learning unit acquiring, using simulation processing and by Q reinforcement learning for each of road surface shape feature amounts of a plurality of patterns, a Q factor where simulation is performed with control parameters of M patterns for the vehicle controller, the Q factor evaluation value having a larger value as the impact applied to the vehicle body decreases, to create a Q table and, on the basis of the Q table, Q-factor relationship information that holds a set of top N (N: an integer satisfying 2 ≤ N < M) Q factors having large Q factors and control parameters for the top N Q factors, for each of the road surface shape feature amounts of the patterns.

### CROSS REFERENCE TO RELATED APPLICATIONS

This application is based on and claims priority under 35 U.S.C. § 119 to Japanese Patent Application No. 2025-016158, filed on February 3, 2025, the entire content of which is incorporated herein by reference.

### TECHNICAL FIELD

The present disclosure relates to a vehicle control device.

### BACKGROUND DISCUSSION

For example, as disclosed in JP 2021-109517 A, in order to mitigate an impact applied from a road surface to a vehicle body of a vehicle (passenger car or the like), vehicle control by a suspension system is conventionally performed, for example. The suspension system controls a damping force adjustment device such as a solenoid actuator or the like in cooperation with, for example, an electronic control unit (ECU) to mitigate an impact applied to the vehicle body from the road surface.

In that case, for example, there is the following method. First, through simulation processing by deep learning using a deep neural network (DNN), a learning model is created by learning the relationship between the road surface shape feature amounts of a plurality of patterns and the control parameters related to the control of the suspension system. Then, when the vehicle travels on an actual road surface (hereinafter, also referred to as “actual environment”), the vehicle control by the suspension system is performed using the control parameters obtained based on the learning model and the road surface shape feature amount of the actual environment.

However, in the above-described conventional technology, when there is a difference between the simulation and the actual environment, there is a case where control parameters suitable for the actual environment cannot be obtained.

A need thus exists for a vehicle control device which is not susceptible to the drawback mentioned above.

### SUMMARY

A vehicle control device mounted on a vehicle, the vehicle control device includes: a vehicle control unit that transmits target control amount information to a suspension system that performs vehicle control for mitigating an impact applied to a vehicle body of the vehicle from a road surface; and a learning unit that acquires, using simulation processing and by Q learning, which is reinforcement learning, for each of one or more road surface shape feature amounts of a plurality of patterns, a Q factor in a case where simulation is performed with each of one or more control parameters of M patterns (M: a predetermined integer of 3 or more) for the vehicle control unit, the Q factor being an evaluation value having a larger value as the impact applied to the vehicle body from the road surface decreases, to create a Q table, creates, on the basis of the Q table, Q-factor relationship information that holds a set of top N (N: an integer satisfying 2 ≤ N < M) Q factors having large Q factors and control parameters corresponding to the top N Q factors, for each of the road surface shape feature amounts of the plurality of patterns,

when the vehicle travels on an actual road surface, using the Q-factor relationship information and an acquired road surface shape feature amount, transmits the control parameter corresponding to any one of the Q factors corresponding to the road surface shape feature amount in the Q-factor relationship information to the vehicle control unit to cause the vehicle control unit to perform vehicle control, acquires a Q factor in a case of the vehicle control to perform update processing of updating the Q factor in the Q-factor relationship information, repeats the update processing, and, in a case where the control parameter is selected for an acquired road surface shape feature amount, when all of N Q factors for the road surface shape feature amount have been updated in the Q-factor relationship information, selects the control parameter corresponding to the largest Q factor among the held Q factors to transmit the selected control parameter to the vehicle control unit.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a perspective view illustrating a state in which a part of a vehicle interior of a vehicle of an embodiment is seen through;

FIG. 2 is a plan view illustrating a state in which a vehicle body of the vehicle of the embodiment is seen through;

FIG. 3 is a block diagram illustrating a configuration of a vehicle control system included in the vehicle of the embodiment;

FIG. 4 is an explanatory diagram of simulation processing by a vehicle control device of the embodiment;

FIG. 5 is an explanatory diagram of processing in an actual environment by the vehicle control device of the embodiment;

FIG. 6 is a diagram illustrating an example of a Q table and the like in the embodiment;

FIG. 7 is a diagram illustrating an example of Q-factor relationship information in the embodiment;

FIG. 8 is a diagram illustrating an example of positional relationship information including a set of a road surface shape feature amount and position information for each spot in the embodiment;

FIG. 9 is an explanatory diagram of updating of the positional relationship information in the embodiment;

FIG. 10 is a flowchart illustrating creation processing of the Q-factor relationship information by the vehicle control device of the embodiment; and

FIG. 11 is a flowchart illustrating processing in the actual environment by the vehicle control device of the embodiment.

### DETAILED DESCRIPTION

Hereinafter, an exemplary embodiment of the present disclosure is disclosed. The configurations of the embodiment shown below, and the actions, results, and effects brought by the configurations are examples. The present disclosure can be achieved by configurations other than those disclosed in the following embodiment, and at least one of various effects based on the basic configuration and derivative effects can be obtained. In addition, in order to simplify the description, in the following description, for example, description of “data” or “information” may be omitted such that “acceleration data” or “acceleration information” is simply referred to as “acceleration”.

A vehicle 1 of the present embodiment may be, for example, an automobile using an internal combustion engine (not illustrated) as a drive source, that is, an internal combustion engine automobile, an automobile using an electric motor (not illustrated) as a drive source, that is, an electric automobile, a fuel cell automobile, or the like, a hybrid automobile using both of them as drive sources, or an automobile including another drive source. In addition, the vehicle 1 can be equipped with various transmission devices, and can be equipped with various devices necessary for driving the internal combustion engine and the electric motor, for example, systems, components, and the like. In addition, the type, number, layout, and the like of devices related to the driving of wheels 3 in the vehicle 1 can be variously set.

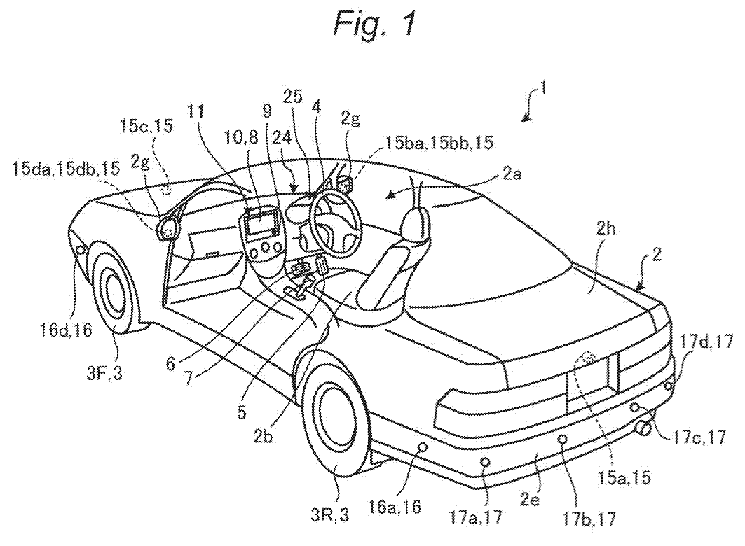

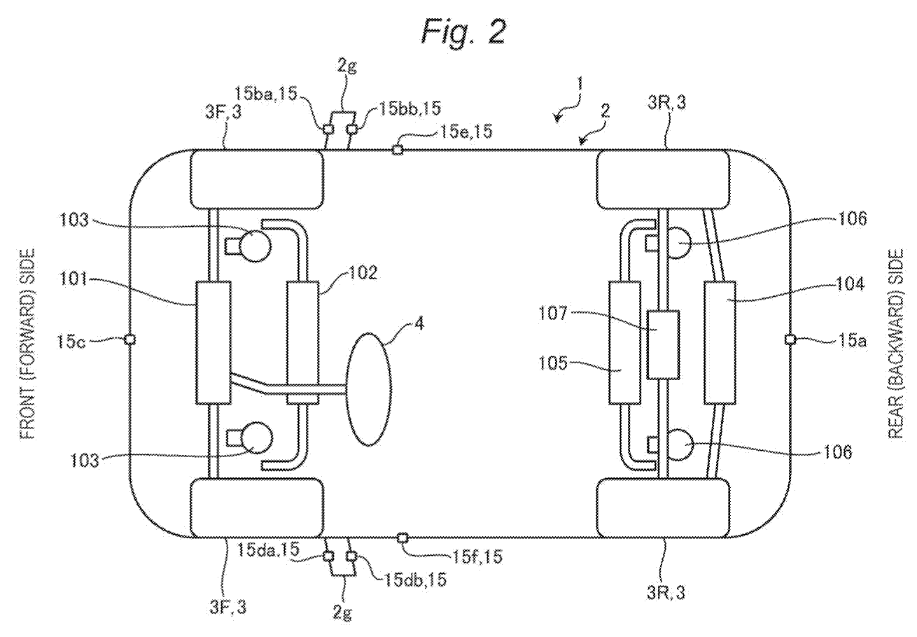

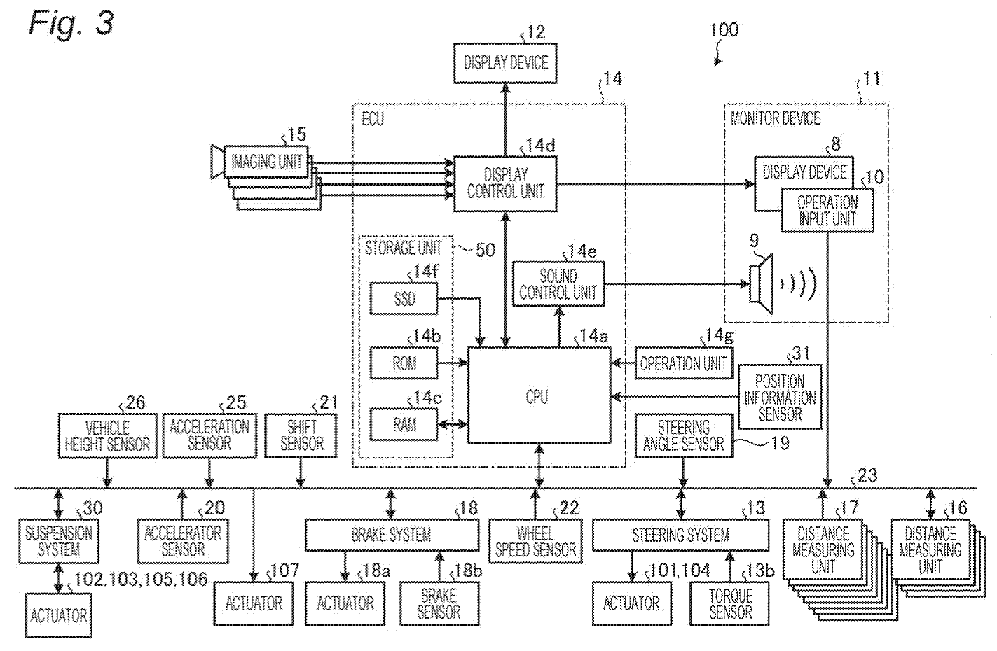

FIG. 1 is a perspective view illustrating a state in which a part of a vehicle interior of the vehicle 1 of an embodiment is seen through. FIG. 2 is a plan view illustrating a state in which a vehicle body of the vehicle of the embodiment is seen through. FIG. 3 is a block diagram illustrating a configuration of a vehicle control system included in the vehicle of the embodiment.

First, an example of a configuration of the vehicle 1 of the present embodiment will be described with reference to FIGS. 1 to 3. As illustrated in FIG. 1, a vehicle body 2 constitutes a vehicle interior 2a to be occupied by an occupant (not illustrated). In the vehicle interior 2a, a steering unit 4, an acceleration operation unit 5, a braking operation unit 6, a transmission operation unit 7, and the like are provided in a state of facing a seat 2b of a driver as an occupant.

The steering unit 4 is, for example, a steering wheel protruding from a dashboard 24. The acceleration operation unit 5 is, for example, an accelerator pedal located at the feet of the driver. The braking operation unit 6 is, for example, a brake pedal located at the feet of the driver. The transmission operation unit 7 is, for example, a shift lever protruding from a center console. Note that the steering unit 4, the acceleration operation unit 5, the braking operation unit 6, the transmission operation unit 7, and the like are not limited thereto.

In the vehicle interior 2a, a display device 8 as a display output unit and a sound output device 9 as a sound output unit are provided. The display device 8 is, for example, a liquid crystal display (LCD), an organic electroluminescent display (OELD), or the like. The sound output device 9 is, for example, a speaker. In addition, the display device 8 is covered with a transparent operation input unit 10 such as a touch panel or the like. The occupant can visually recognize the image displayed on the display screen of the display device 8 via the operation input unit 10. In addition, the occupant can perform an operation input by touching, pressing, or moving the operation input unit 10 with a finger or the like at a position corresponding to an image displayed on the display screen of the display device 8.

The display device 8, the sound output device 9, the operation input unit 10, and the like are provided in, for example, a monitor device 11 located at the center of the dashboard 24 in the vehicle width direction, that is, the left-right direction. The monitor device 11 can include an operation input unit (not illustrated) such as a switch, a dial, a joystick, a push button, or the like. In addition, a sound output device (not illustrated) can be provided at another position in the vehicle interior 2a different from the monitor device 11, and sound can be output from the sound output device 9 of the monitor device 11 and another sound output device. Note that the monitor device 11 can also be used as, for example, a navigation system or an audio system. In the vehicle interior 2a, a display device 12 different from the display device 8 is provided.

As illustrated in FIG. 2, the vehicle 1 is, for example, a four-wheeled automobile, and includes two, left and right, front wheels 3F and two, left and right, rear wheels 3R. All of these four wheels 3 can be configured to be turnable. As illustrated in FIG. 3, the vehicle 1 includes a steering system 13 that steers at least two wheels 3.

As illustrated in FIG. 3, the steering system 13 includes actuators 101, 104 and a torque sensor 13b. The steering system 13 is electrically controlled by an electronic control unit (ECU) 14 or the like to operate the actuators 101, 104. Here, as illustrated in FIG. 2, the actuator 101 is connected to the front wheels 3F and is a front steering actuator for turning the front wheels 3F. The actuator 104 is connected to the rear wheels 3R and is a rear steering actuator for turning the rear wheels 3R.

The steering system 13 is, for example, an electric power steering system, a steer by wire (SBW) system, or the like. The steering system 13 applies torque, that is, assist torque, to the steering unit 4 by the actuators 101, 104 to supplement the steering force, or turns the wheels 3 by the actuators 101, 104. In this case, the actuators 101, 104 may turn one wheel 3 or may turn a plurality of wheels 3. In addition, the torque sensor 13b detects, for example, a torque applied to the steering unit 4 by the driver.

Furthermore, as illustrated in FIG. 3, the vehicle body 2 is provided with, for example, eight imaging units 15a to 15f as a plurality of imaging units 15. The imaging units 15 are, for example, digital cameras incorporating an imaging element such as a charge coupled device (CCD), a CMOS image sensor (CIS), or the like. The imaging units 15 can output moving image data at a predetermined frame rate. Each of the imaging units 15 includes a wide-angle lens or a fisheye lens, and can capture an image in a range of, for example, 140° to 190° in the horizontal direction. The optical axis of the imaging units 15 is set obliquely downward. Therefore, the imaging units 15 sequentially capture an image of an external environment around the vehicle body 2 including a road surface on which the vehicle 1 can move and an area where the vehicle 1 can be parked, and outputs the image as a captured image (image data).

The imaging units 15a are located, for example, on an end portion 2e on the rear side of the vehicle body 2, and are provided in a wall portion below a door 2h of a rear trunk. The imaging unit 15ba is located, for example, on the right side of the vehicle body 2, that is, on an end portion on the right side in the vehicle width direction, and is provided on the front side (forward side) relative to the door mirror 2g as a projection on the right side. The imaging unit 15bb is located, for example, on the right side of the vehicle body 2, that is, on an end portion on the right side in the vehicle width direction, and is provided on the rear side (backward side) relative to the door mirror 2g as the projection on the right side.

The imaging unit 15c is located, for example, on the front side of the vehicle body 2, that is, on an end portion on the front side in the vehicle front-rear direction, and is provided on a front bumper or the like. The imaging unit 15da is located, for example, on the left side of the vehicle body 2, that is, on an end portion on the left side in the vehicle width direction, and is provided on the front side (forward side) relative to the door mirror 2g as a projection on the left side. The imaging unit 15db is located, for example, on the left side of the vehicle body 2, that is, on an end portion on the left side in the vehicle width direction, and is provided on the rear side (backward side) relative to the door mirror 2g as the projection on the left side.

The imaging unit 15e is located, for example, on the right side of the vehicle body 2, that is, on an end portion on the right side in the vehicle width direction, and is provided near a door on the right side. The imaging unit 15f is located, for example, on the left side of the vehicle body 2, that is, on an end portion on the left side in the vehicle width direction, and is provided near a door on the left side.

The ECU 14 can execute arithmetic processing and image processing on the basis of the image data obtained by the plurality of imaging units 15 to generate an image with a wider viewing angle or generate a virtual overhead image of the vehicle 1 viewed from above. Note that the overhead image can also be referred to as a planar image. In the present embodiment, each imaging unit 15 captures an image of an area around the vehicle 1.

As illustrated in FIG. 1, as a plurality of distance measuring units 16, 17, the vehicle body 2 is provided with, for example, four distance measuring units 16a to 16d and eight distance measuring units 17a to 17h. The distance measuring units 16, 17 are sonars that emit ultrasonic waves and capture reflected waves thereof, for example. The sonar may also be referred to as a sonar sensor or an ultrasonic detector. The ECU 14 can measure the presence or absence of an object such as an obstacle or the like located around the vehicle 1 and the distance to the object in the detection results of the distance measuring units 16, 17. That is, the distance measuring units 16, 17 are examples of detection units that detect an object. Note that the distance measuring units 17 can be used, for example, to detect an object at a relatively short distance, and the distance measuring units 16 can be used, for example, to detect an object at a relatively long distance farther than the distance measuring units 17. Furthermore, the distance measuring units 17 can be used, for example, to detect objects in front of and behind the vehicle 1, and the distance measuring units 16 can be used to detect objects on the lateral sides of the vehicle 1.

Furthermore, as illustrated in FIG. 3, in a vehicle control system 100, in addition to the ECU 14, the monitor device 11, the steering system 13, the distance measuring units 16, 17, and the like, a brake system 18, a suspension system 30, a steering angle sensor 19, an accelerator sensor 20, a shift sensor 21, a wheel speed sensor 22, an acceleration sensor 25, a vehicle height sensor 26, a spring sensor 27, an actuator 107, and the like are electrically connected via an in-vehicle network 23 as an electric communication line. The in-vehicle network 23 is configured as, for example, a controller area network (CAN). The ECU 14 is an example of an estimation device and a vehicle control device.

The ECU 14 controls the steering system 13, the brake system 18, the suspension system 30, the actuator 107, and the like by sending a control signal through the in-vehicle network 23. Furthermore, the ECU 14 receives, for example, detection results of the torque sensor 13b, a brake sensor 18b, the steering angle sensor 19, the distance measuring units 16, the distance measuring units 17, the accelerator sensor 20, the shift sensor 21, the wheel speed sensor 22, the acceleration sensor 25, the vehicle height sensor 26, and the like, and operation signals of the operation input unit 10 and the like via the in-vehicle network 23.

The ECU 14 includes, for example, a central processing unit (CPU) 14a, a read only memory (ROM) 14b, a random access memory (RAM) 14c, a display control unit 14d, a sound control unit 14e, a solid state drive (SSD, flash memory) 14f, and the like.

The CPU 14a executes various types of arithmetic processing and control such as image processing related to images displayed on the display devices 8, 12, determination of a target position of the vehicle 1, arithmetic operation of a movement route of the vehicle 1, determination of presence or absence of interference with an object, automatic control of the vehicle 1, cancellation of the automatic control, damping control, spring constant switching control, steering control, stabilizer control, driving force control, and the like. The CPU 14a reads a program installed and stored in a nonvolatile storage device such as the ROM 14b or the like, and executes arithmetic processing according to the program.

The RAM 14c temporarily stores various types of data used in the arithmetic operation in the CPU 14a. In addition, among the arithmetic processing in the ECU 14, the display control unit 14d mainly executes image processing using the image data obtained by the imaging units 15, composition of image data displayed on the display device 8, and the like. In addition, among the arithmetic processing in the ECU 14, the sound control unit 14e mainly executes processing of sound data output by the sound output device 9. The SSD 14f is a rewritable nonvolatile storage unit, and can store data even when the power supply of the ECU 14 is turned off. The CPU 14a, the ROM 14b, the RAM 14c, and the like can be integrated in the same package. In addition, the ECU 14 may have a configuration in which, instead of the CPU 14a, another logical operation processor such as a digital signal processor (DSP) or the like, a logic circuit, or the like is used. In addition, a hard disk drive (HDD) may be provided instead of the SSD 14f, and the SSD 14f and the HDD may be provided separately from the ECU 14.

A position information sensor 31 is a sensor that acquires the current position of the vehicle 1, and corresponds to, for example, a global positioning system (GPS) receiver or the like. The position information sensor 31 sends the acquired current position to the CPU 14a as position information.

The brake system 18 is, for example, an anti-lock brake system (ABS) that suppresses locking of a brake, an electronic stability control (ESC) that suppresses sideslip of the vehicle 1 at the time of cornering, an electric brake system that enhances braking force (executes brake assist), a brake by wire (BBW), or the like. The brake system 18 applies a braking force to the wheels 3 and thus the vehicle 1 via the actuator 18a. In addition, the brake system 18 can execute various types of controls by detecting a lock of the brake, idle rotation of the wheels 3, a sign of sideslip, and the like from a rotation difference between the left and right wheels 3 and the like. The brake sensor 18b is, for example, a sensor that detects the position of a movable portion of the braking operation unit 6. The brake sensor 18b can detect a position of the brake pedal as the movable portion. The brake sensor 18b includes a displacement sensor.

The actuator 107 is a rear driving force control actuator illustrated in FIG. 2, and is an actuator for controlling the driving force of the rear wheels 3R by being electrically controlled by the ECU 14 or the like.

The steering angle sensor 19 is, for example, a sensor that detects a steering amount of the steering unit 4 such as a steering wheel or the like. The steering angle sensor 19 is configured using, for example, a Hall element or the like. The ECU 14 acquires from the steering angle sensor 19 the steering amount of the steering unit 4 by the driver, the steering amount of each wheel 3 at the time of automatic steering, and the like and executes various types of controls. Note that the steering angle sensor 19 detects the rotation angle of the rotating portion included in the steering unit 4.

The accelerator sensor 20 is, for example, a sensor that detects the position of a movable portion of the acceleration operation unit 5. The accelerator sensor 20 can detect a position of the accelerator pedal as the movable portion. The accelerator sensor 20 includes a displacement sensor.

The shift sensor 21 is, for example, a sensor that detects the position of the movable portion of the transmission operation unit 7. The shift sensor 21 can detect the position of a lever, an arm, a button, or the like as the movable portion. The shift sensor 21 may include a displacement sensor or may be configured as a switch.

The wheel speed sensor 22 is a sensor that detects the rotation amount of the wheels 3 and the number of rotations per unit time. The wheel speed sensor 22 outputs the number of wheel speed pulses indicating the detected number of rotations as a sensor value. The wheel speed sensor 22 can be configured using, for example, a Hall element or the like. The ECU 14 performs arithmetic operation of a movement amount and the like of the vehicle 1 based on the sensor value acquired from the wheel speed sensor 22 and executes various types of controls. The wheel speed sensor 22 may be provided in the brake system 18 in some cases. In this case, the ECU 14 acquires the detection result of the wheel speed sensor 22 via the brake system 18.

The vehicle height sensor 26 is a sensor that detects a stroke displacement of each wheel.

The suspension system 30 is a system that performs vehicle control for mitigating an impact applied to the vehicle body of the vehicle 1 from a road surface, and is disposed between the vehicle body 2 and the wheels 3 of the vehicle 1. The suspension system 30 includes a spring that absorbs vibration of the vehicle 1 due to an impact on the vehicle 1 from a road surface, and a damping force variable damper that can damp the vibration of the spring and change a damping force of the vibration of the spring. In the present embodiment, the suspension system 30 controls a damping force adjustment device such as a solenoid actuator or the like in cooperation with the ECU 14 to change the damping force of the damping force variable damper. As a result, the suspension system 30 achieves a damping force control system that damps the vibration in the up-down direction, the lateral direction, and the front-rear direction of the vehicle body due to the impact on the vehicle 1 from the road surface.

The acceleration sensor 25 is provided in the vicinity of each of a portion of the vehicle on the vehicle body 2 side (hereinafter, also referred to as “sprung” portion) with respect to the suspension system 30 and a portion of the vehicle 1 on the wheels 3 side (hereinafter, also referred to as “unsprung” portion) with respect to the suspension system 30. The acceleration sensor 25 includes a vertical acceleration sensor (that is, a sprung G sensor and an unsprung G sensor) that detects and outputs an acceleration in the up-down direction of the vehicle body 2, a longitudinal acceleration sensor that detects and outputs an acceleration in the front-rear direction of the vehicle body 2 (vehicle 1), and a lateral acceleration sensor that detects and outputs a lateral acceleration which is an acceleration in the lateral direction (width direction) of the vehicle body 2 (vehicle 1).

Here, the vertical acceleration sensor is a sprung acceleration sensor (hereinafter, also referred to as “sprung G sensor”) that detects a sprung acceleration (hereinafter, also referred to as “sprung G”), and an unsprung acceleration sensor (hereinafter, also referred to as “unsprung G sensor”) that detects an unsprung acceleration (hereinafter, also referred to as “unsprung G”).

The suspension system 30 is electrically controlled by the ECU 14 or the like to operate actuators 102, 103, 105, 106 for damping force control and stabilizer control.

Here, as illustrated in FIG. 2, the actuator 102 is a front active stabilizer actuator provided on the suspension on the front wheels 3F side for controlling the stabilizer on the front wheels 3F side. As illustrated in FIG. 2, the actuator 105 is a rear active stabilizer actuator provided on the suspension on the rear wheels 3R side to control the stabilizer on the rear wheels 3R side.

As illustrated in FIG. 2, the actuator 103 is a front damping force control actuator provided on the suspension on the front wheels 3F side for damping force control on the front wheels 3F side. As illustrated in FIG. 2, the actuator 106 is a rear damping force control actuator provided on the suspension on the rear wheels 3R side for damping force control on the rear wheels 3R side.

Note that the configurations, arrangements, electrical connection forms, and the like of the various types of sensors and actuators described above are examples, and can be variously set (changed).

Next, a vehicle control device achieved by the ECU 14 will be described. Hereinafter, the ECU 14 may be referred to as a vehicle control device 14 in some cases. Note that, in the present specification, the road surface shape is a concept including not only the shape itself of the road surface but also all elements of the road surface related to the impact applied to the vehicle body, such as the state of the road surface (dry, wet with water, snowy, icy, etc.) and the material of the road.

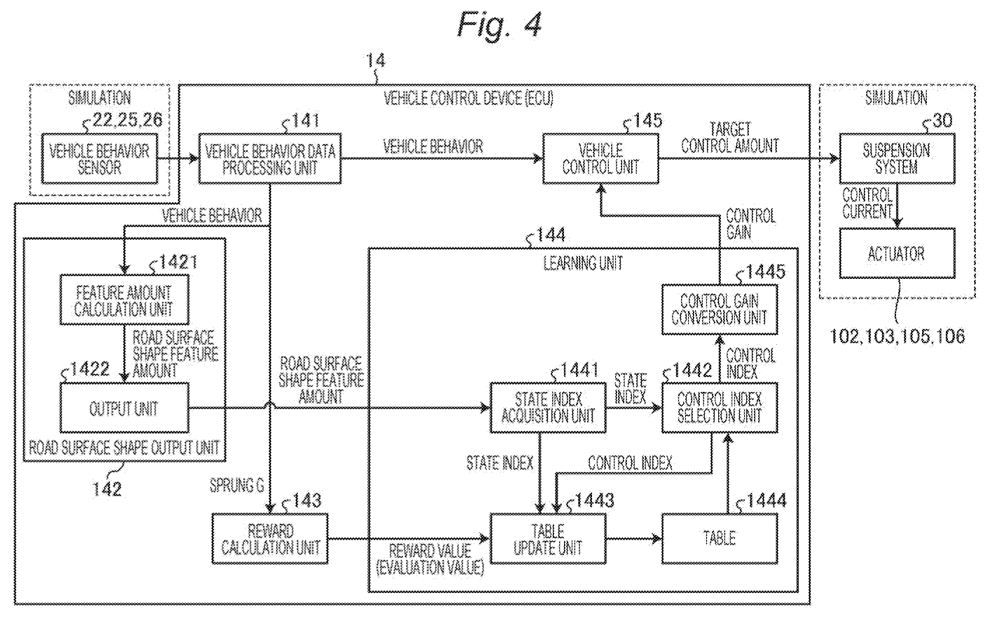

FIG. 4 is an explanatory diagram of simulation processing by the vehicle control device 14 of the embodiment. As illustrated in FIG. 4, the vehicle control device 14 mainly includes, as functional units, a vehicle behavior data processing unit 141, a road surface shape output unit 142, a reward calculation unit 143, a learning unit 144, and a vehicle control unit 145.

These functional units are implemented by the CPU 14a reading and executing a program stored in a storage unit 50 (FIG. 3). Here, the storage unit 50 includes a ROM 14b, a RAM 14c, and an SSD 14f. That is, the program may include, as an example, a module corresponding to each functional unit of the vehicle control device 14 illustrated in FIG. 4. In addition, the module of each functional unit can also be achieved by independent hardware such as a circuit or the like including an application specific integrated circuit (ASIC).

Here, the vehicle behavior sensor is the sprung G sensor in the acceleration sensor 25, the wheel speed sensor 22, the vehicle height sensor 26, or the like in simulation. The vehicle behavior data output by the vehicle behavior sensor is data related to the behavior of the vehicle 1, and corresponds to, for example, a sprung acceleration (sprung G), a vehicle height, a vehicle speed, a sprung speed, a vehicle height change speed, an unsprung speed, and the like.

The vehicle behavior data processing unit 141 acquires vehicle behavior data output by the vehicle behavior sensor and calculates vehicle behavior (including sprung G).

For example, the vehicle behavior data processing unit 141 inputs the sprung acceleration (sprung G) which is a detection signal from the sprung G sensor in the acceleration sensor 25, and outputs the sprung acceleration as vehicle behavior data. In addition, the vehicle behavior data processing unit 141 inputs a wheel speed which is a detection signal of the wheel speed sensor 22, calculates a vehicle speed which is a speed of the vehicle 1 from the wheel speed, and outputs the calculated vehicle speed as vehicle behavior data. In addition, the vehicle behavior data processing unit 141 inputs the vehicle height, which is the height of vehicle 1, as a detection signal from the vehicle height sensor 26, and outputs the vehicle height as vehicle behavior data.

Furthermore, the vehicle behavior data processing unit 141 integrates the sprung acceleration detected by the sprung G sensor to obtain the sprung speed, and outputs the sprung speed as vehicle behavior data. In addition, the vehicle behavior data processing unit 141 differentiates the sensor data of the vehicle height detected by the vehicle height sensor to obtain the vehicle height change speed, and outputs the vehicle height change speed as vehicle behavior data. In addition, the vehicle behavior data processing unit 141 obtains an unsprung speed from a difference between the sprung speed and the vehicle height change speed, and outputs the unsprung speed as vehicle behavior data.

In other words, the vehicle behavior data processing unit 141 outputs the sprung acceleration (sprung G), the vehicle height, the vehicle speed, the sprung speed, the vehicle height change speed, the unsprung speed, and the like as the vehicle behavior data to the vehicle control unit 145 as the vehicle behavior data. In addition, the vehicle behavior data processing unit 141 outputs the sprung G to the reward calculation unit 143.

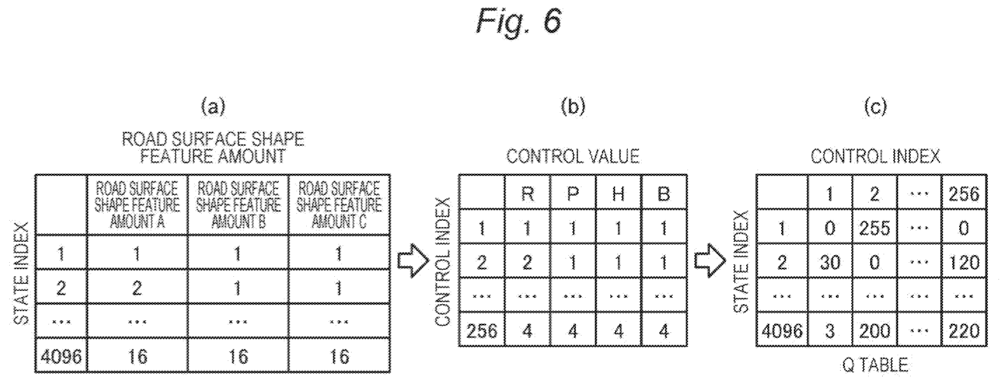

The road surface shape output unit 142 includes a feature amount calculation unit 1421 and an output unit 1422. Here, FIG. 6 is a diagram illustrating an example of a Q table and the like in the embodiment. As illustrated in (a) of FIG. 6, the feature amount calculation unit 1421 calculates road surface shape feature amounts A, B, and C.

The road surface shape feature amount A is a heave (vertical movement) component of the vibration of a center-of-gravity portion of the vehicle 1.

The road surface shape feature amount B is a roll (lateral tilting) component of the vibration of the center-of-gravity portion of the vehicle 1.

The road surface shape feature amount C is a pitch (longitudinal tilting) component of the vibration of the center-of-gravity portion of the vehicle 1.

The feature amount calculation unit 1421 calculates each of the road surface shape feature amounts A, B, and C using, for example, information such as an unsprung acceleration of each of the four wheels 3. Hereinafter, the road surface shape feature amounts A, B, and C may be simply referred to as “road surface shape feature amounts” in some cases.

The output unit 1422 outputs the road surface shape feature amounts received from the feature amount calculation unit 1421 to a state index acquisition unit 1441 of the learning unit 144.

The reward calculation unit 143 inputs the sprung acceleration from the vehicle behavior data processing unit 141, calculates a reward value (evaluation value) by a predetermined reward function, and outputs the calculated reward value to a table update unit 1443 of the learning unit 144.

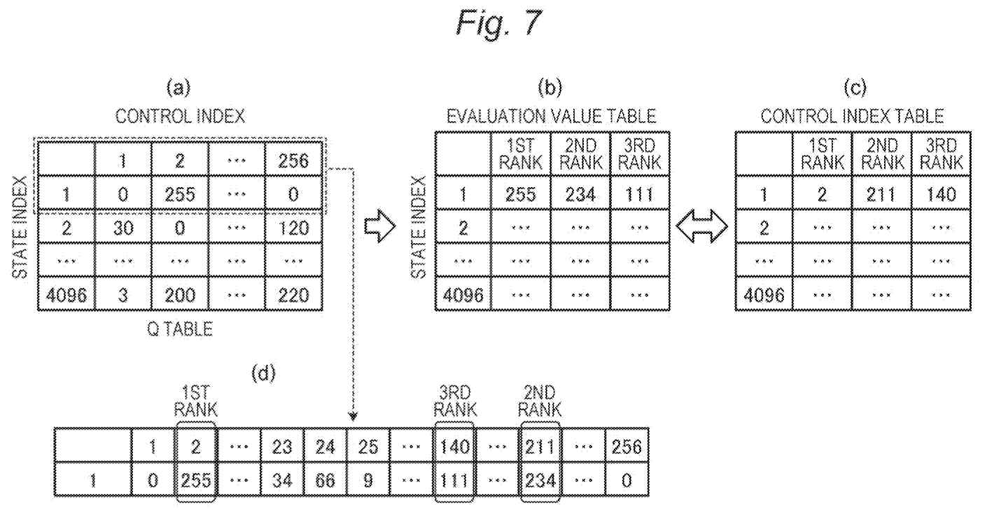

Using simulation processing and by Q learning, which is reinforcement learning, the learning unit 144 acquires, for each of one or more (three in the example of (a) of FIG. 6) road surface shape feature amounts of a plurality of patterns (4096 patterns in the example of (a) of FIG. 6), a Q factor in a case where simulation is performed with each of one or more (four in the example of (b) of FIG. 6) control parameters (control values) of M patterns (M: a predetermined integer of 3 or more) (256 patterns in the example of (b) of FIG. 6) for the vehicle control unit 145, the Q factor being an evaluation value (reward value) having a larger value as the impact applied to the vehicle body from the road surface decreases, to create a Q table ((c) of FIG. 6). In addition, on the basis of the Q table ((c) of FIG. 6), the learning unit 144 creates Q-factor relationship information ((b) and (c) of FIG. 7) that holds a set of top N (N: an integer satisfying 2 ≤ N < M) (the top 3 in the example of FIG. 7) Q factors having large Q factors and control parameters corresponding to the top N Q factors, for each of the road surface shape feature amounts of the plurality of patterns (4096 patterns). These will be described in detail below.

The learning unit 144 includes the state index acquisition unit 1441, a control index selection unit 1442, the table update unit 1443, a table 1444, and a control gain conversion unit 1445.

The state index acquisition unit 1441 inputs a road surface shape feature amount from the output unit 1422, and transmits a state index ((a) of FIG. 6) corresponding to the road surface shape feature amount to the control index selection unit 1442 and the table update unit 1443.

Here, (b) of FIG. 6 is a table illustrating a control value for each control index. The control value can take four-stage values of 1, 2, 3, and 4 for each of R (roll), P (pitch), H (heave), and B (base).

For the state index input from the state index acquisition unit 1441, the control index selection unit 1442 outputs the control index according to the number of times the state index has been selected, for example, sequentially from 1 to 256 control indexes, to the table update unit 1443 and the control gain conversion unit 1445.

The control gain conversion unit 1445 converts the control index into a control gain. The control gain is a parameter used to calculate a target control amount for the vehicle control unit 145 that gives the target control amount to the suspension system 30. The vehicle control unit 145 transmits the target control amount to the suspension system 30. Specifically, the vehicle control unit 145 calculates the target control amount based on the vehicle behavior data and the control gain input from the vehicle behavior data processing unit 141, and outputs the calculated target control amount to the suspension system 30. As a result, the suspension system 30 commands a control current to the actuators 102, 103, 105, 106 so as to reach the target control amount, and performs damping force control and the like.

For the state index acquired from the state index acquisition unit 1441, the table update unit 1443 acquires an evaluation value (reward value) (Q factor) of a case where a simulation (simulation by the suspension system 30) based on the control parameter (control value) corresponding to the control index acquired from the control index selection unit 1442 is performed, and creates (updates) the Q table ((c) of FIG. 6).

By repeating the above-described processing, the Q table ((c) of FIG. 6) is completed. Then, as illustrated in FIG. 7, the table update unit 1443 creates Q-factor relationship information ((b) and (c) of FIG. 7) that holds a set of the top three Q factors having a large Q factor and the control indexes corresponding to the Q factors for each state index from the Q table ((a) of FIG. 7).

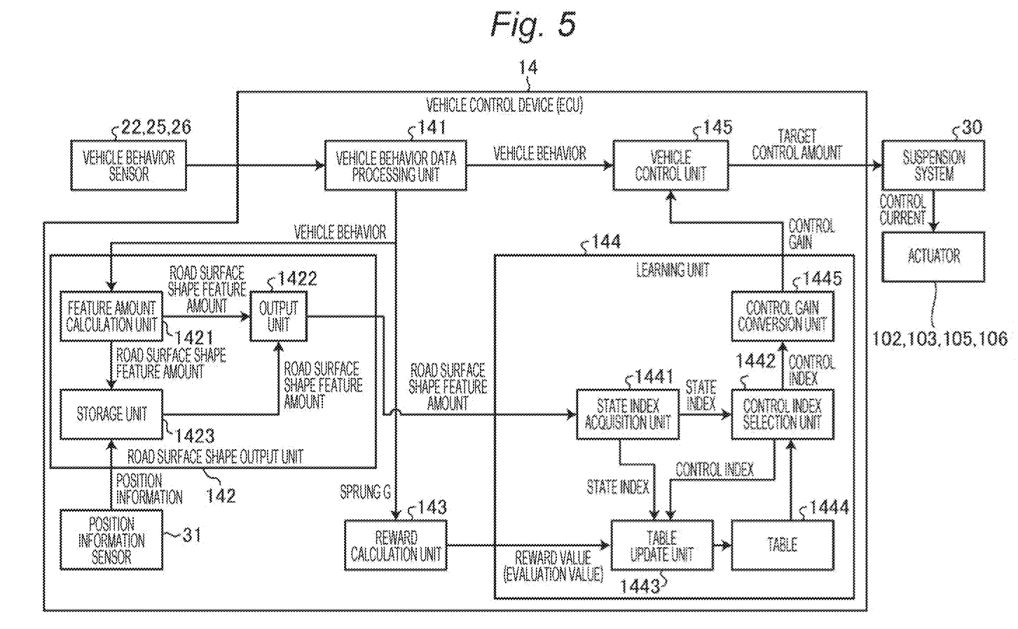

Next, processing in an actual environment will be described. FIG. 5 is an explanatory diagram of processing in an actual environment by the vehicle control device 14 of the embodiment. When the vehicle 1 travels on the actual road surface, using the Q-factor relationship information ((b) and (c) of FIG. 7) and an acquired road surface shape feature amount, the learning unit 144 transmits a control parameter corresponding to any one of the Q factors corresponding to the road surface shape feature amount in the Q-factor relationship information ((b) and (c) of FIG. 7) to the vehicle control unit 145 to cause the vehicle control unit 145 to perform vehicle control, acquires the Q factor in a case of the vehicle control to perform update processing of updating the Q factor in the Q-factor relationship information ((b) and (c) of FIG. 7).

In addition, the learning unit 144 repeats the update processing, and, in a case where the control parameter is selected for the acquired road surface shape feature amount, when all the N (three) Q factors for the road surface shape feature amount have been updated in the Q-factor relationship information ((b) and (c) of FIG. 7), the learning unit 144 selects the control parameter corresponding to the largest Q factor among the held Q factors to transmit the selected control parameter to the vehicle control unit 145. These will be described in detail below.

The road surface shape output unit 142 further includes a storage unit 1423. The storage unit 1423 stores the position information of the road and the road surface shape feature amount in association with each other. When the road surface shape feature amount associated with the position information exists in the storage unit 1423, the output unit 1422 outputs the associated road surface shape feature amount. When the associated road surface shape feature amount does not exist, the output unit 1422 outputs the road surface shape feature amount calculated by the feature amount calculation unit 1421.

The control index selection unit 1442 acquires a state index from the state index acquisition unit 1441, and selects a control index from the control index table ((c) of FIG. 7) according to the number of times the state index has been selected. For example, the first-ranked control index ((b) and (c) of FIG. 7) is output in the first selection, the second-ranked control index ((b) and (c) of FIG. 7) is output in the second selection, the third-ranked control index ((b) and (c) of FIG. 7) is output in the third selection, and the control index corresponding to the largest evaluation value (Q factor) is output in the fourth and subsequent selections. Note that, a predetermined control index may be output in the first selection, the first-ranked control index ((b) and (c) of FIG. 7) may be output in the second selection, the second-ranked control index ((b) and (c) of FIG. 7) may be output in the third selection, the third-ranked control index ((b) and (c) of FIG. 7) may be output in the fourth selection, and the control index corresponding to the largest evaluation value may be output in the fifth and subsequent selections.

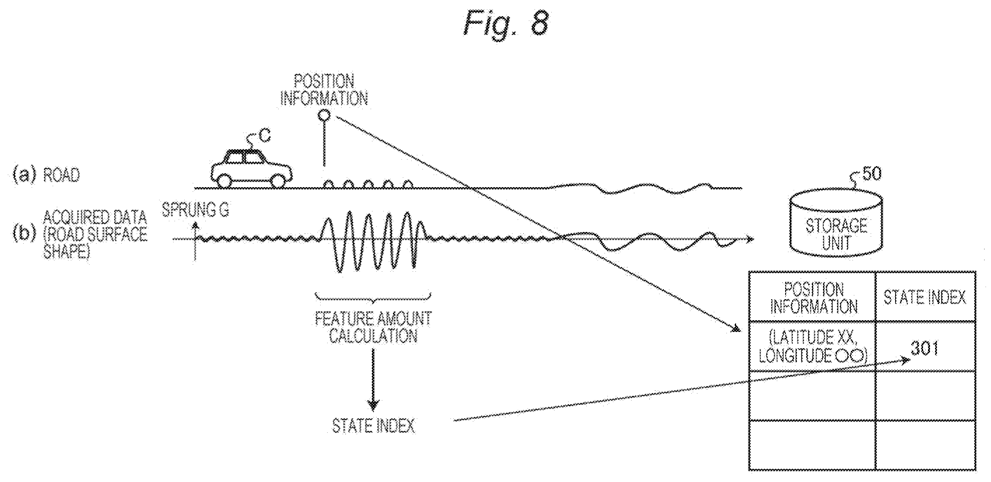

Here, FIG. 8 is a diagram illustrating an example of positional relationship information including a set of a road surface shape feature amount and position information for each spot in the embodiment. For example, in a case where the vehicle 1 travels on an actual predetermined road surface a plurality of times, the learning unit 144 stores, in a first travel, for each spot, a set of an acquired road surface shape feature amount (state index) and position information of the spot in the positional relationship information of the storage unit 50, and acquires, in second and subsequent travels, the road surface shape feature amount (state index) based on the current position information of the vehicle 1 and the positional relationship information to perform subsequent processing.

In addition, for example, in a case where the control parameter is selected for an acquired road surface shape feature amount, when all of N (three) Q factors for the road surface shape feature amount have been updated in the Q-factor relationship information, the learning unit 144 may select the control parameter corresponding to the largest Q factor among the held Q factors to transmit the selected control parameter to the vehicle control unit 145, and, when a new Q factor acquired at the time of the vehicle control by the vehicle control unit 145 has changed more than a predetermined change threshold, may update the Q-factor relationship information with the new Q factor.

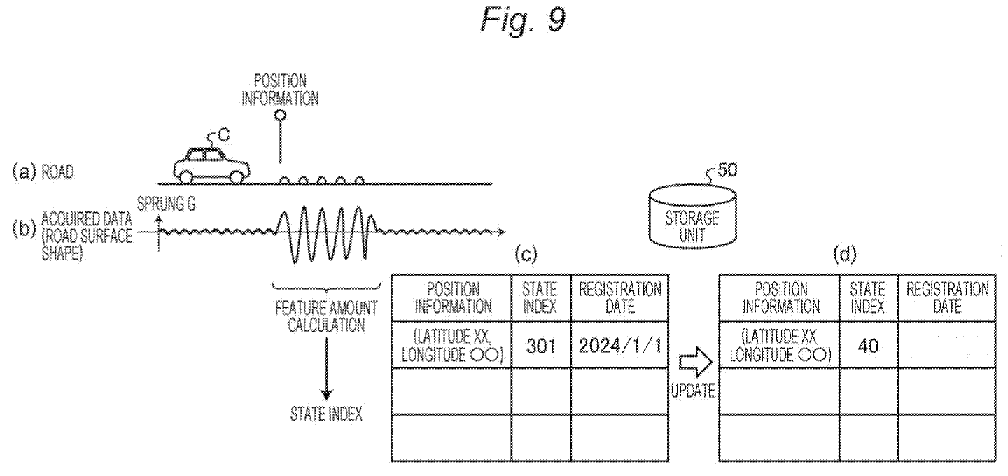

FIG. 9 is an explanatory diagram of updating of the positional relationship information in the embodiment. With respect to the predetermined road surface, for each spot, when a predetermined period has elapsed after the set of the acquired road surface shape feature amount and position information of the spot is stored in the positional relationship information of the storage unit 50, the learning unit 144 may acquire, for the spot, a road surface shape feature amount again and may update the positional relationship information, and may acquire the road surface shape feature amount based on the current position information of the vehicle and the updated positional relationship information to perform subsequent processing in next and subsequent travels.

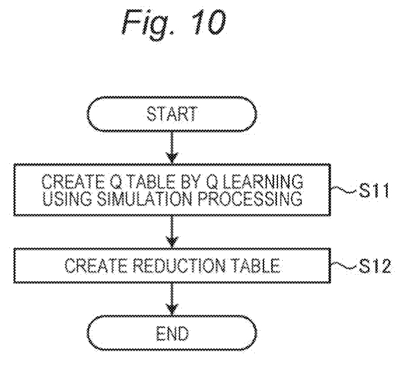

Next, creation processing of the Q-factor relationship information by the vehicle control device 14 will be described. FIG. 10 is a flowchart illustrating creation processing of the Q-factor relationship information by the vehicle control device 14 of the embodiment. Reference is also made to FIG. 4.

In step S11, using the simulation processing and by Q learning, the learning unit 144 acquires, for each of one or more road surface shape feature amounts of a plurality of patterns, a Q factor in a case where a simulation with one or more control parameters (control values) of the M patterns for the vehicle control unit 145 is performed, and creates a Q table ((c) of FIG. 6).

In addition, in step S12, on the basis of the Q table ((c) of FIG. 6), the learning unit 144 creates a reduction table (Q-factor relationship information) ((b) and (c) of FIG. 7) that holds a set of the top N Q factors having large Q factors and control parameters corresponding to the Q factors, for each of the road surface shape feature amounts of the plurality of patterns.

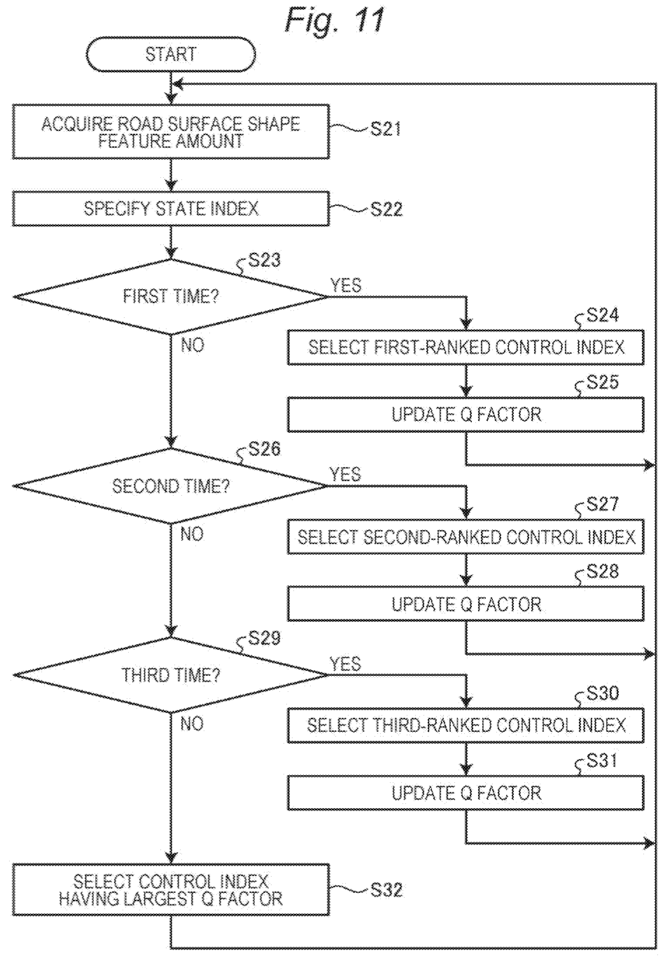

Next, processing in an actual environment by the vehicle control device 14 will be described. FIG. 11 is a flowchart illustrating processing in the actual environment by the vehicle control device 14 of the embodiment. Reference is also made to FIG. 5.

In step S21, the state index acquisition unit 1441 acquires the road surface shape feature amount from the output unit 1422 of the road surface shape output unit 142.

Next, in step S22, the control index selection unit 1442 specifies a state index corresponding to the road surface shape feature amount acquired in step S21 ((b) of FIG. 7).

Next, in step S23, the control index selection unit 1442 determines whether or not the state index specified in step S22 has been selected for the first time. If Yes, the process proceeds to step S24, and if No, the process proceeds to step S26.

In step S24, the control index selection unit 1442 specifies the first-ranked control index ((c) of FIG. 7).

Next, vehicle control by the suspension system 30 is performed using the specified control index, and in step S25, the table update unit 1443 updates the Q factor in (b) of FIG. 7 accordingly, and the process returns to step S21.

In step S26, the control index selection unit 1442 determines whether or not the state index specified in step S22 has been selected for the second time. If Yes, the process proceeds to step S27, and if No, the process proceeds to step S29.

In step S27, the control index selection unit 1442 specifies the second-ranked control index ((c) of FIG. 7).

Next, vehicle control by the suspension system 30 is performed using the specified control index, and in step S28, the table update unit 1443 updates the Q factor in (b) of FIG. 7 accordingly, and the process returns to step S21.

In step S29, the control index selection unit 1442 determines whether or not the state index specified in step S22 has been selected for the third time. If Yes, the process proceeds to step S30, and if No, the process proceeds to step S32.

In step S30, the control index selection unit 1442 specifies the third-ranked control index ((c) of FIG. 7).

Next, vehicle control by the suspension system 30 is performed using the specified control index, and in step S31, the table update unit 1443 updates the Q factor in (b) of FIG. 7 accordingly, and the process returns to step S21.

In the processing up to step S31, the evaluation value table of (b) of FIG. 7 has contents (Q factors) suitable for the actual environment.

In step S32, the control index selection unit 1442 specifies the control index having the largest Q factor ((b) of FIG. 7). Thereafter, vehicle control by the suspension system 30 is performed using the specified control index.

As described above, according to the vehicle control device 14 of the present embodiment, after the Q table ((c) of FIG. 6) is created using the simulation processing, the reduction table (Q-factor relationship information) ((b) and (c) of FIG. 7) is created, and thereafter, when the vehicle 1 travels on the actual road surface, the update processing of the reduction table is performed. As a result, even when there is a difference between the simulation and the actual environment regarding the control parameter related to the control of the suspension system 30, a control parameter suitable for the actual environment can be obtained.

In addition, in a case where the vehicle 1 travels on an actual predetermined road surface a plurality of times, in a first travel, as illustrated in FIG. 8, for each spot, a set of an acquired road surface shape feature amount and the position information of the spot is stored in the positional relationship information of the storage unit 50. As a result, when the vehicle 1 travels on the predetermined road surface for the second and subsequent times, the appropriate road surface shape feature amount can be acquired using the positional relationship information to perform the subsequent processing. Therefore, for example, in a case where the vehicle 1 travels on the same road every day, comfortable ride of the user in the vehicle 1 can be achieved.

In addition, as illustrated in FIG. 9, when a predetermined period has elapsed after the positional relationship information is stored in the storage unit 50, the road surface shape feature amount is acquired again for the spot and the positional relationship information is updated. As a result, for example, even when the road surface shape changes due to road construction or the like, the vehicle 1 can be controlled using the optimum control parameter according to the change.

In addition, after the Q-factor relationship information ((b) and (c) of FIG. 7) is updated by the processing in the actual environment, when a new Q factor acquired at the time of vehicle control by the vehicle control device 14 has changed more than a predetermined change threshold, the Q-factor relationship information may be updated with the new Q factor. As a result, in a case where there is any change in the vehicle 1 that affects the Q factor, such as a change in tire pressure, deterioration of parts, or the like, the vehicle 1 can be controlled using an optimum control parameter according to the change.

Note that, in the case of a technique based on deep learning using a DNN of the conventional technology, since there are many parameters in general, a large amount of memory is required. Then, since it is necessary to repeat learning, it takes time, and thus it is difficult to directly update the DNN in the vehicle 1.

On the other hand, according to the technique of the present embodiment, there is no disadvantage thereof. Specifically, for example, since the reduction table ((b) and (c) of FIG. 7) is created by narrowing down the Q table, the memory use amount can be suppressed to be significantly small.

Note that the vehicle control program executed by the vehicle control device 14 of the above embodiment is provided by being incorporated in advance in, for example, the ROM 14b or the like.

In addition, the vehicle control program may be configured to be provided by being stored in a computer-readable recording medium such as a CD-ROM, a flexible disk (FD), a CD-R, a digital versatile disk (DVD), or the like as a file in an installable format or an executable format.

Furthermore, the vehicle control program may be stored on a computer connected to a network such as the Internet and provided by being downloaded via the network. Furthermore, the vehicle control program may be provided or distributed via a network such as the Internet.

Although an embodiment of the present disclosure has been described, the embodiment has been presented by way of example and is not intended to limit the scope of the disclosure. This novel embodiment can be implemented in various other forms, and various omissions, substitutions, and changes can be made without departing from the gist of the disclosure. In addition, this embodiment and its modifications are included in the scope and gist of the disclosure, and are included in the disclosure described in the claims and the equivalent scope thereof.

For example, in the example of (a) of FIG. 6, the number (types) of the road surface shape feature amounts is three, but the number is not limited thereto, and may be another number such as six. In addition, the number of state indexes is not limited to 4096, and may be another number.

In the example of (b) of FIG. 6, the number (types) of the control values is four, but the number is not limited thereto, and may be another number such as three, five, or six. In addition, the number of control indexes is not limited to 256, and may be another number. The number of stages of the control value is not limited to four stages, and may be another number of stages.

In addition, in the examples of (b) and (c) of FIG. 7, the top three pieces of data of the Q factor are held, but the number of pieces of data is not limited to the top three, and another number of pieces of data such as the top four pieces of data may be held.

### Summary of Present Embodiment

The present embodiment includes at least the following configurations.

(1) A vehicle control device mounted on a vehicle, the vehicle control device includes: a vehicle control unit that transmits target control amount information to a suspension system that performs vehicle control for mitigating an impact applied to a vehicle body of the vehicle from a road surface; and a learning unit that acquires, using simulation processing and by Q learning, which is reinforcement learning, for each of one or more road surface shape feature amounts of a plurality of patterns, a Q factor in a case where simulation is performed with each of one or more control parameters of M patterns (M: a predetermined integer of 3 or more) for the vehicle control unit, the Q factor being an evaluation value having a larger value as the impact applied to the vehicle body from the road surface decreases, to create a Q table, creates, on the basis of the Q table, Q-factor relationship information that holds a set of top N (N: an integer satisfying 2 ≤ N < M) Q factors having large Q factors and control parameters corresponding to the top N Q factors, for each of the road surface shape feature amounts of the plurality of patterns, when the vehicle travels on an actual road surface, using the Q-factor relationship information and an acquired road surface shape feature amount, transmits the control parameter corresponding to any one of the Q factors corresponding to the road surface shape feature amount in the Q-factor relationship information to the vehicle control unit to cause the vehicle control unit to perform vehicle control, acquires a Q factor in a case of the vehicle control to perform update processing of updating the Q factor in the Q-factor relationship information, repeats the update processing, and, in a case where the control parameter is selected for an acquired road surface shape feature amount, when all of N Q factors for the road surface shape feature amount have been updated in the Q-factor relationship information, selects the control parameter corresponding to the largest Q factor among the held Q factors to transmit the selected control parameter to the vehicle control unit.

With such a configuration, even when there is a difference between the simulation and the actual environment regarding the control parameter related to the control of the suspension system, a control parameter suitable for the actual environment can be obtained.

(2) In the vehicle control device, in a case where the vehicle travels on an actual predetermined road surface a plurality of times, the learning unit stores, in a first travel, for each spot, a set of an acquired road surface shape feature amount and position information of the spot in a positional relationship information of a storage unit, and acquires, in second and subsequent travels, the road surface shape feature amount based on current position information of the vehicle and the positional relationship information to perform subsequent processing.

With such a configuration, when the vehicle travels on the predetermined road surface for the second and subsequent times, the appropriate road surface shape feature amount can be acquired using the positional relationship information to perform the subsequent processing.

(3) In the vehicle control device, with respect to the predetermined road surface, for each spot, when a predetermined period has elapsed after the set of the acquired road surface shape feature amount and position information of the spot is stored in the positional relationship information of the storage unit, the learning unit acquires, for the spot, a road surface shape feature amount again and updates the positional relationship information, and acquires the road surface shape feature amount based on current position information of the vehicle and the updated positional relationship information to perform subsequent processing in next and subsequent travels.

With such a configuration, for example, even when the road surface shape changes due to road construction or the like, the vehicle can be controlled using the optimum control parameter according to the change.

(4) In the vehicle control device, in a case where the control parameter is selected for an acquired road surface shape feature amount, when all of N Q factors for the road surface shape feature amount have been updated in the Q-factor relationship information, the learning unit selects the control parameter corresponding to the largest Q factor among the held Q factors to transmit the selected control parameter to the vehicle control unit, and, when a new Q factor acquired at the time of the vehicle control by the vehicle control unit has changed more than a predetermined change threshold, updates the Q-factor relationship information with the new Q factor.

With such a configuration, in a case where there is any change in the vehicle that affects the Q factor, such as a change in tire pressure, deterioration of parts, or the like, the vehicle can be controlled using an optimum control parameter according to the change.

Note that the effects of the dependent claims and the embodiment are additional effects different from the effects of the independent claim.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A vehicle control device mounted on a vehicle, the vehicle control device comprising:
a vehicle control unit that transmits target control amount information to a suspension system that performs vehicle control for mitigating an impact applied to a vehicle body of the vehicle from a road surface; and
a learning unit that acquires, using simulation processing and by Q learning, which is reinforcement learning, for each of one or more road surface shape feature amounts of a plurality of patterns, a Q factor in a case where simulation is performed with each of one or more control parameters of M patterns (M: a predetermined integer of 3 or more) for the vehicle control unit, the Q factor being an evaluation value having a larger value as the impact applied to the vehicle body from the road surface decreases, to create a Q table, creates, on the basis of the Q table, Q-factor relationship information that holds a set of top N (N: an integer satisfying 2 ≤ N < M) Q factors having large Q factors and control parameters corresponding to the top N Q factors, for each of the road surface shape feature amounts of the plurality of patterns,
when the vehicle travels on an actual road surface, using the Q-factor relationship information and an acquired road surface shape feature amount, transmits the control parameter corresponding to any one of the Q factors corresponding to the road surface shape feature amount in the Q-factor relationship information to the vehicle control unit to cause the vehicle control unit to perform vehicle control, acquires a Q factor in a case of the vehicle control to perform update processing of updating the Q factor in the Q-factor relationship information, repeats the update processing, and,
in a case where the control parameter is selected for an acquired road surface shape feature amount, when all of N Q factors for the road surface shape feature amount have been updated in the Q-factor relationship information, selects the control parameter corresponding to the largest Q factor among the held Q factors to transmit the selected control parameter to the vehicle control unit.

2. The vehicle control device according to claim 1, wherein,
in a case where the vehicle travels on an actual predetermined road surface a plurality of times,
the learning unit
stores, in a first travel, for each spot, a set of an acquired road surface shape feature amount and position information of the spot in a positional relationship information of a storage unit, and
acquires, in second and subsequent travels, the road surface shape feature amount based on current position information of the vehicle and the positional relationship information to perform subsequent processing.

3. The vehicle control device according to claim 2, wherein,
with respect to the predetermined road surface,
for each spot, when a predetermined period has elapsed after the set of the acquired road surface shape feature amount and position information of the spot is stored in the positional relationship information of the storage unit,
the learning unit
acquires, for the spot, a road surface shape feature amount again and updates the positional relationship information, and
acquires the road surface shape feature amount based on current position information of the vehicle and the updated positional relationship information to perform subsequent processing in next and subsequent travels.

4. The vehicle control device according to claim 1, wherein,
in a case where the control parameter is selected for an acquired road surface shape feature amount, when all of N Q factors for the road surface shape feature amount have been updated in the Q-factor relationship information,
the learning unit
selects the control parameter corresponding to the largest Q factor among the held Q factors to transmit the selected control parameter to the vehicle control unit, and, when a new Q factor acquired at the time of the vehicle control by the vehicle control unit has changed more than a predetermined change threshold, updates the Q-factor relationship information with the new Q factor.
